(19) United States
(12) Patent Application Publication
(10) Pub. No.: US 2020/0384736 A1
(43) Pub. Date: Dec. 10, 2020

(54) AERONAUTICAL LAMINATED GLAZING WITH HIGH RESISTANCE TO BREAKING ON BIRD STRIKE

(71) Applicant: SAINT-GOBAIN GLASS FRANCE, COURBEVOIE (FR)

(72) Inventor: Thomas TONDU, SAINT-MARTIN D'ABBAT (FR)

(21) Appl. No.: 16/772,514

(22) PCT Filed: Dec. 11, 2018
(86) PCT No.: PCT/FR2018/053207

§ 371 Date: Jun. 12, 2020

(30) Foreign Application Priority Data
Dec. 13, 2017 (FR) 1762049

(51) Int. Cl. B32B 17/10

(52) U.S. Cl. CPC B32B 17/10018; B32B 17/10064; B32B 17/10385; B32B 2605/18; B32B 2605/006; B32B 2307/558; B32B 17/10137

(57) ABSTRACT

A laminated glazing for a vehicle or a building, includes an inner structural polymer material sheet and an outer structural glass sheet having a breaking stress of from 350 to 1000 MPa under the stress characteristics of a bird strike.

The mechanical sizing of aeronautical glazings is governed by the requirement of resistance to impacts by birds. The weight of the glazings is therefore strongly governed by the requirement of bird strike resistance. This invention is a reduced-weight glazing composition consisting of a structural glass having a high breaking stress and of a tough structural plastic. The breaking stress is also sometimes referred to as the modulus of rupture (MOR).

Currently, aeronautical glazings are formed of at least two plies in order to ensure safety in the event of one ply breaking. A third ply may be added on the outer face to manage aerodynamic requirements and/or as support for the heating function for deicing.

The plies providing mechanical properties are referred to as structural plies: they are either:
two glass plies with high breaking stress; or
two or more plies made of polymer material: as-cast or stretched polymethyl methacrylate (PMMA), polycarbonate (PC), polyurethane (PU).

Saving weight is a permanent requirement of the aeronautical industry. Glazings with two structural plies made of glass on the one hand and of stretched PMMA on the other hand, make it possible to attain weights that are substantially similar to laminated glazing.

Glazings made of polycarbonate enable a weight reduction, but the polycarbonate furthermore has many defects:
high scratch sensitivity;
continuous degradation of the mechanical performance over time;
yellowing under UV radiation;
tendency to delaminate;
fatigue failure (with respect to the alternations of pressure increases and decreases) at the attachments (holes in the PC sheet for bolting);
lower elastic modulus which leads to significant deformations of the glazings under the effects of the aircraft pressurization.

During the impact of a bird, the glazing is locally bent, which induces stresses in the glazings. It is the surface furthest from the impact that receives the highest stresses which may give rise to the breakage of the inner structural ply of the aircraft laminated glazing. On the contrary, the outer structural ply is tensilely stressed very little, or even is placed under compression, which protects it. In the direction of the bird strike, from the outside to the inside of the aircraft, the structural block of the laminated glazing is subjected to compressive stresses then to tensile stresses, the two types of stresses being separated by a plane referred to as a “neutral axis” (zero load) within the structural block.

The objective of the invention is to combine two structural sheets in order to push back the breaking point of the laminated glazing with respect to a bird strike. This objective is achieved by the invention, one subject of which is, consequently, a laminated glazing for a vehicle or a building, characterized in that it comprises an inner structural polymer material sheet and an outer structural glass sheet with a thickness of between 3 and 20 mm having a breaking stress of from 350 to 1000 MPa under the stress characteristics of a bird strike.

The invention consists of the creation of a structural block formed of a glass with high breaking stress on the outermost face of the structural block and of a polymer material placed on the inner face of the glazing and characterized by a low elastic modulus.

The glass has a high elastic modulus of the order of around 70 GPa, much higher than that of the polymer materials (a few GPa under the stress conditions of a bird strike). It is therefore the glass which mainly determines the deformations of the glazing.

Compared to a glazing with two structural glasses, the neutral axis (of zero load) is shifted toward the outside of the structural block in the assembly position of the laminated glazing, more specifically within the outer structural glass: the loading thereof is therefore increased. In other words, the outer structural glass sheet is here under tensile stress. The inner structural polymer material sheet is deformed very little owing to the stiffness of the glass. Furthermore, due to its low elastic modulus, the polymer material requires greater deformations than the glass to become loaded.

Owing to the invention, it is possible to optimize the weight of the laminated glazing by seeking to simultaneously reach the breaking point on the glass and on the polymer material, which is impossible when the two structural plies are of the same type.

Compared to an aircraft laminated glazing in which the two structural plies would be made of glass or of PMMA, the glazing of the invention simulataneously provides better bird strike performance, in particular, and a weight saving of the structural block of the order of 20% for example.

The complete encapsulation of the outer structural glass sheet allows the choice of superficial chemical reinforcements that make it possible to attain higher levels of reinforcement than glasses with deep reinforcement. It is specified that deep reinforcement makes it possible to prevent the loss of mechanical performance by scratching of the surface, which cannot occur in the case of encapsulation.

According to other features of the laminated glazing of the invention:
the inner structural polymer material sheet is made of stretched or unstretched poly(methyl methacrylate) (PMMA), of structural polyurethane (PU) or of polycarbonate (PC), with a thickness of between 5 and 22 mm;
the outer structural glass sheet is made of soda-lime or aluminosilicate glass;
the outer structural glass sheet is chemically reinforced; the chemical reinforcement consists for example of the substitution of sodium ions by potassium ions, or of lithium ions by sodium ions, i.e. each time by larger ions, at the surface of the glass sheets; it is this which increases their surface compressive stress and their breaking stress;
the inner and outer structural sheets are bonded to one another by means of a first adhesive interlayer having a thickness of between 0.5 and 5, preferably between 1.8 and 3.2 mm;
the laminated glazing comprises, on the side of the outer structural glass sheet opposite the inner structural polymer material sheet, an outer glass sheet having a thickness between 0.5 and 5 mm; this thin and nonstructural outer glass sheet constitutes the outer surface of the laminated glazing, in contact with the outside atmosphere;
the outer glass sheet is of soda-lime or aluminosilicate type;
the outer glass sheet is semi-tempered or chemically reinforced;
the outer glass sheet is bonded to the outer structural glass sheet by means of a second adhesive interlayer having a thickness of between 2 and 12, preferably 3 and 7 mm;
the face of the outer glass sheet oriented toward the outer structural glass sheet supports a network of heating wires and/or an electrically-conductive heating layer; copper wires, layer of tin-doped indium oxide ITO (indium tin oxide), connected to an electrical power supply by means of collectors (busbars); this positioning of the heating function provides the deicing of the surface of the laminated glazing in contact with the outside atmosphere, under all usage conditions, while minimizing the electric power required (proximity of the ice);
one face of the inner or outer structural sheet supports a network of heating wires and/or an electrically-conductive heating layer as described above; this positioning of the heating function provides the demisting of the surface of the laminated glazing in contact with the atmosphere of the aircraft cockpit;
the face of the outer glass sheet opposite the outer structural glass sheet is flush with the assembly structure; in other words, this face is in the continuity of the structure (aircraft body); an essential function of the outer glass sheet is the aerodynamic performance of the aircraft, and to a lesser extent the appearance;
an adhesive interlayer comprises a polyvinyl butyral (PVB), a polyurethane (PU), an ethylene/vinyl acetate copolymer (EVA) or the like;
the laminated glazing is curved (concavity toward the inside of the vehicle or of the building in the assembly position);
a reinforcing sheet is inserted between the inner and outer structural glass sheets, over a portion at least of a peripheral zone of the laminated glazing; this is a strip of reinforcing material such as metal or fiber composite (Kevlar® or the like) material, along a significant portion of the peripheral zone of the laminated glazing; this reinforcing sheet is subjected to the local stress applied by the windowpane retainer and which would risk locally breaking the outer structural glass into small pieces; the reinforcing sheet prevents the tearing of the adhesive interlayer at the contact boundary between windowpane retainer and glazing.

A further subject of the invention is the use of a laminated glazing as described above in aeronautics, in particular as commercial, regional or business aircraft glazing subject to the requirements of bird strike resistance.

The invention is now illustrated by the following exemplary embodiment.

### EXAMPLE

A laminated glazing of pressurized commercial aircraft cockpit consists, from the inside of the aircraft outward:
of a 10-mm thick inner structural sheet of stretched PMMA;
of an 8-mm thick outer structural sheet of chemically reinforced soda-lime glass having a breaking stress of 500 MPa; and
of a semi-tempered (surface stress of 50 MPa) 3-mm thick outer soda-lime glass sheet.

The two structural sheets are bonded by means of a 2-mm thick PVB adhesive interlayer.

The outer structural glass sheet and the outer glass sheet are bonded by means of a 10-mm thick PU adhesive interlayer.

The face of the outer glass sheet oriented toward the outer structural glass sheet bears a deicing heating layer of ITO. This is in particular the case for a frontal deicing glazing of an aircraft cockpit. As specified above, in the case of a demisting glazing, the heating function may be supported by any surface of the structural block in the laminate.

The outer face of the outer glass sheet is flush with the body of the aircraft, assembly environment of the laminated glazing.

This laminated glazing has improved bird strike resistance.

1. A laminated glazing for a vehicle or a building, comprising an inner structural polymer material sheet and an outer structural glass sheet with a thickness of between 3 and 20 mm having a breaking stress of from 350 to 1000 MPa under the stress characteristics of a bird strike.

2. The laminated glazing as claimed in claim 1, wherein the inner structural polymer material sheet is made of stretched or unstretched poly(methyl methacrylate) (PMMA), of structural polyurethane (PU) or of polycarbonate (PC), with a thickness of between 5 and 22 mm.

3. The laminated glazing as claimed in claim 1, wherein the outer structural glass sheet is made of soda-lime or aluminosilicate glass.

4. The laminated glazing as claimed in claim 1, wherein the outer structural glass sheet is chemically reinforced.

5. The laminated glazing as claimed in claim 1, wherein the inner and outer structural sheets are bonded to one another by means of a first adhesive interlayer having a thickness of between 0.5 and 5 mm.

6. The laminated glazing as claimed in claim 1, comprising, on a side of the outer structural glass sheet opposite the inner structural polymer material sheet, an outer glass sheet having a thickness of between 0.5 and 5 mm.

7. The laminated glazing as claimed in claim 6, wherein the outer glass sheet has a soda-lime or aluminosilicate composition.

8. The laminated glazing as claimed in claim 6, wherein the outer glass sheet is semi-tempered or chemically reinforced.

9. The laminated glazing as claimed in claim 6, wherein the outer glass sheet is bonded to the outer structural glass sheet by means of a second adhesive interlayer having a thickness of between 2 and 12 mm.

10. The laminated glazing as claimed in claim 6, wherein the face of the outer glass sheet oriented toward the outer structural glass sheet supports a network of heating wires and/or an electrically-conductive heating layer.

11. The laminated glazing as claimed in claim 1, wherein one face of the inner or outer structural sheet supports a network of heating wires and/or an electrically-conductive heating layer.

12. The laminated glazing as claimed in claim 6, wherein the face of the outer glass sheet opposite the outer structural glass sheet is flush with the assembly structure.

13. The laminated glazing as claimed in claim 5, wherein an adhesive interlayer comprises a polyvinyl butyral, a polyurethane, an ethylene/vinyl acetate copolymer or the like.

14. The laminated glazing as claimed in claim 1, wherein the laminated glazing is curved.

15. The laminated glazing as claimed in claim 1, comprising a reinforcing sheet that is inserted between the inner and outer structural glass sheets, over a portion at least of a peripheral zone of the laminated glazing.

16. A method comprising utilizing a laminated glazing as claimed in claim 1 in aeronautics.

17. The method as claimed in claim 16, wherein the laminated glazing is a commercial, regional or business aircraft glazing subject to the requirements of bird strike resistance.

18. The laminated glazing as claimed in claim 5, wherein the thickness of the first adhesive interlayer is between 1.8 and 3.2 mm.

19. The laminated glazing as claimed in claim 9, wherein the thickness of the second adhesive interlayer is between 3 and 7 mm.
